(19) United States
(12) Patent Application Publication
(10) Pub. No.: US 2020/0322943 A1
(43) Pub. Date: Oct. 8, 2020

(54) Method and Apparatus for Confirming Media Access Control Control Element and Communication System

(71) Applicant: FUJITSU LIMITED, Kawasaki-shi (JP)

(72) Inventors: Yulong SHI, Beijing (CN); Lei ZHANG, Beijing (CN)

(73) Assignee: FUJITSU LIMITED, Kawasaki-shi (JP)

(21) Appl. No.: 16/910,763

(22) Filed: Jun. 24, 2020

Related U.S. Application Data
(63) Continuation of application No. PCT/CN2018/077046, filed on Feb. 23, 2018.

(51) Int. Cl. H04W 72/04; H04W 72/12; H04W 72/10; H04W 28/06; H04L 5/00; H04L 29/06

(52) U.S. Cl. CPC H04W 72/0406; H04W 72/1242; H04L 69/28; H04W 28/06; H04L 5/0053; H04W 72/10

(57) ABSTRACT

A method and apparatus for confirming a media access control control element and a communication system. The method includes: receiving by a first device an MAC CE transmitted by a second device; and transmitting by the first device an confirmation MAC CE confirming that the first device successfully receives the MAC CE.

### CROSS REFERENCE TO RELATED APPLICATIONS

This application is a continuation application of International Application No. PCT/CN2018/077046, filed on Feb. 23, 2018, the contents of which are incorporated herein by reference.

### TECHNICAL FIELD

This disclosure relates to the field of communications, and in particular to a method and apparatus for confirming a media access control control element and a communication system.

### BACKGROUND

In recent years, various data applications and services based on mobile communication networks have grown rapidly. Terminals served by mobile communication networks have also been expanded from traditional smartphone terminals that are mainly used by humans to more types of terminals that are mainly based on machines.

In order to adapt to this changing trend, future mobile communication networks need to have abilities to provide more flexible and diverse services to meet demands of different terminal equipments and different services. For example, in addition to traditional enhanced mobile broadband (eMBB) services, 5G communication systems also support massive machine type communications (mMTC) services and ultra-reliable and low-latency communications (URLLC) services.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Although much enhancement has been made to reliability of data transmission in existing techniques, reliability enhancement of signaling for configuring data transmission modes and resources is still insufficient.

For example, the reliability of configuration signaling of existing media access control control element (MAC CE) is much lower than reliability of URLLC data transmission. Failure to enhance the reliability of MAC CE may result in URLLC-related configuration errors, large configuration latency, or inconsistent understanding of configuration on the network device side and terminal equipment side, which will eventually result in URLLC data transmission not to meet requirements on low latency and high reliability. In addition, MAC CEs related to URLLC services need to be more reliable than other MAC CEs.

Embodiments of this disclosure provide a method and apparatus for confirming a media access control control element (MAC CE) and a communication system, in which the first device receiving the MAC CE transmits an confirmation MAC CE confirming that the first device successfully receives the MAC CE, thereby improving reliability of the MAC CE.

According to a first aspect of the embodiments of this disclosure, there is provided an apparatus for confirming a media access control control element (MAC CE), provided in a first device, the apparatus including: a first receiving unit configured to receive an MAC CE transmitted by a second device; and a first transmitting unit configured to transmit an confirmation MAC CE confirming that the first receiving unit successfully receives the MAC CE.

According to a second aspect of the embodiments of this disclosure, there is provided an apparatus for confirming a media access control control element (MAC CE), provided in a second device, the apparatus including:

a second transmitting unit configured to transmit an MAC CE to a first device; and a second receiving unit configured to receive an confirmation MAC CE confirming that the first device successfully receives the MAC CE and transmitted by the first device.

According to a third aspect of the embodiments of this disclosure, there is provided a communication system, including a first device and a second device, the first device including the apparatus for confirming an MAC CE as described in the first aspect, and the second device including the apparatus for confirming an MAC CE as described in the second aspect.

An advantage of the embodiments of this disclosure exists in that reliability of the MAC CE may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one implementation may be used in the same way or in a similar way in one or more other embodiments and/or in combination with or instead of the features of the other embodiments.

It should be emphasized that the term “comprise/include” when used in this specification is taken to specify the presence of stated features, integers, blocks or components but does not preclude the presence or addition of one or more other features, integers, blocks, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one implementation.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communication system of an embodiment of this disclosure;

FIG. 2 is a schematic diagram of the method for confirming an MAC CE of Embodiment 1 of this disclosure;

FIG. 3 is a schematic diagram of the method for confirming an MAC CE of Embodiment 2 of this disclosure;

FIG. 4 is a schematic diagram of the apparatus for confirming an MAC CE of Embodiment 3 of this disclosure;

FIG. 5 is a schematic diagram of the apparatus for confirming an MAC CE of Embodiment 4 of this disclosure;

FIG. 6 is a schematic diagram of a structure the network device of Embodiment 6 of this disclosure;

FIG. 7 is a schematic diagram of a structure of the terminal equipment of Embodiment 6 of this disclosure;

FIG. 8 is a schematic diagram of a method for applying configuration in RRC configuration signaling of Embodiment 8 of this disclosure;

FIG. 9 is a schematic diagram of a method for applying configuration in RRC configuration signaling of Embodiment 9 of this disclosure;

FIG. 10 is a schematic diagram of an apparatus for applying configuration in RRC configuration signaling of Embodiment 10 of this disclosure;

FIG. 11 is a schematic diagram of an apparatus for applying configuration in RRC configuration signaling of Embodiment 11 of this disclosure;

FIG. 12 is a schematic diagram of a structure of the terminal equipment of Embodiment 12 of this disclosure; and

FIG. 13 is a schematic diagram of a structure of the network device of Embodiment 13 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of this disclosure shall be described below with reference to the accompanying drawings, and these embodiments are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios in the embodiments of this disclosure shall be described below by way of examples; however, this disclosure is not limited thereto.

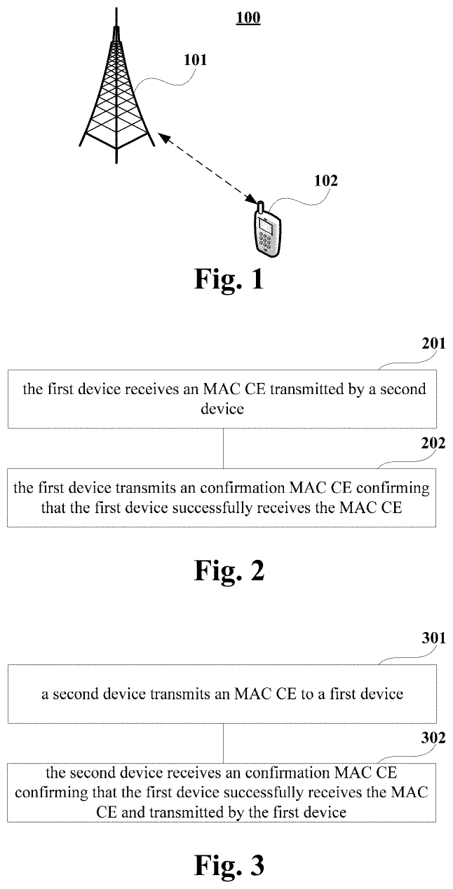

FIG. 1 is a schematic diagram of a communication system of this disclosure, in which a case where a terminal equipment and a network device are taken as examples is schematically shown. As shown in FIG. 1, a communication system 100 may include a network device 101 and a terminal equipment 102 (or the sake of simplicity, description is given in FIG. 1 by taking one terminal equipment only as an example).

In the embodiment of this disclosure, existing services or services that may be implemented in the future may be performed between the network device 101 and the terminal equipment 102. For example, such services may include but not limited to an enhanced mobile broadband (eMBB), massive machine type communication (MTC), and ultra-reliable and low-latency communication (URLLC), etc. In this disclosure, the embodiments shall be described by taking a URLLC service sensitive to latency as an example; however, this disclosure is not limited thereto, and it is also applicable to other services sensitive to latency.

The terminal equipment 102 may transmit data the network device 101, such as in a granted or grant-free transmission mode. The network device 101 may receive data transmitted by one or more terminal equipments 102, and feed back information to the terminal equipment 102, such as acknowledgement (ACK)/non-acknowledgement (NACK) information, etc. According to the feedback information, the terminal equipment 102 may acknowledge the end of the transmission process, or may perform new data transmission, or may perform data retransmission.

Moreover, before the terminal equipment 102 accesses to the network device 101, the network device 101 may transmit information on system information to the terminal equipment 102, and the terminal equipment 102 may detect the received information to achieve downlink synchronization, and establish connection with the network device 101.

Following description shall be given by taking that one of a network device and a terminal equipment in the communication system is taken as a transmitter end and the other is taken as a receiver end as an example. However, this application is not limited thereto, and the transmitter end and the receiver may also be other devices. For example, this application is not only applicable to signal transmission between a network device and a terminal equipment, but is also applicable to signal transmission between two terminal equipments.

### Embodiment 1

Embodiment 1 of this disclosure provides a method for confirming a media access control control element (MAC CE), which is performed by a first device.

FIG. 2 is a schematic diagram of the method for confirming an MAC CE of this embodiment. As shown in FIG. 2, the method includes:

block 201: the first device receives an MAC CE transmitted by a second device; and

block 202: the first device transmits an confirmation MAC CE confirming that the first device successfully receives the MAC CE.

According to this embodiment, the first device transmits the confirmation MAC CE, hence, it can be confirmed that the first device successfully receives the MAC CE, thereby improving the reliability of the MAC CE.

In this embodiment, the first device is a device that receives the MAC CE and transmits the confirmation MAC CE, and the first device may be one of a network device and a terminal equipment. The second device is a device that transmits the MAC CE and receives the confirmation MAC CE. The second device may be the other one of the network device and the terminal equipment. The first device and the second device perform communication and constitute a communication system.

In this embodiment, when the first device is instructed by the second device, the first device may transmit the confirmation MAC CE; and furthermore, when the first device is not instructed by the second device, the first device does not transmit the confirmation MAC CE. Hence, the second device may instruct for a MAC CE, so that the first device transmits the confirmation MAC CE for the MAC CE.

In one implementation, the MAC CE transmitted by the second device is used to instructe that the first device transmits the confirmation MAC CE.

For example, a field of a data portion or a subheader portion of the MAC CE transmitted by the second device is used to instruct the first device to transmit the confirmation MAC CE. In one example, when a field of the data portion or subheader portion of the MAC CE transmitted by the second device is set to be 1, it instructs the first device to transmit the confirmation MAC CE for the MAC CE; and furthermore, when the field is set to be 0, the first device does not transmit an confirmation MAC CE for the MAC CE, and vice versa.

For another example, a logical channel identifier (LCID) used by the MAC CE transmitted by the second device is used to instruct the first device to transmit the confirmation MAC CE. In one example, a MAC CE may correspond to at least two LCIDs, such as LCID1 and LCID2; when the MAC CE received by the first device uses LCD 1, the first device transmits the confirmation MAC CE for the MAC CE; and furthermore, when the MAC CE received by the first device uses LCID2, the first device does not transmit an confirmation MAC CE for the MAC CE.

For another example, a position of the MAC CE transmitted by the second device in a media access control protocol data unit (MAC PDU) received by the first device is used to instruct the first device to transmit the confirmation MAC CE. In one example, when the MAC CE received by the first device is at the end of the entire MAC PDU, that is, after a media access control service data unit (MAC SDU), the first device transmits the confirmation MAC CE for the MAC CE; and furthermore, when the MAC CE received by the first device is in the front of the entire MAC PDU, that is, before the MAC SDU, the first device does not transmit an confirmation MAC CE for the MAC CE, and vice versa.

In this embodiment, other information transmitted by the second device may also be used to instruct the first device to transmit the confirmation MAC CE.

In this embodiment, when the first device is configured by a network device in the first device and the second device, the first device transmits the confirmation MAC CE. For example, when the first device is a terminal equipment and the second device is a network device, the first device may be configured by a network device serving as the second device; when the first device is a network device and the second device is a terminal equipment, the first device itself may be configured by a network device serving as the first device. Hence, the first device may transmit the confirmation MAC CE according to the configuration of the network device, without needing the second device to instruct for each MAC CE.

In one implementation, the first device may be configured by the network device to: at a moment when the first device receives first network signaling or within a duration starting from a moment instructed by the first network signaling, transmit the confirmation MAC CE. The first network signaling may be, for example, physical layer signaling, or an MAC CE, or radio resource control (RRC) signaling, or other network signaling. And the moment instructed by the first network signaling may be, for example, a moment of a system frame, or a subframe, or a slot, or a symbol position, and the like, instructed by the first network signaling.

For example, a length of the duration may be determined by a timer configured by the network device, and/or the first device may be configured by the network device to terminate transmission of the confirmation MAC CE at a moment when second network signaling is received or at a moment instructed by the second network signaling. The second network signaling may be, for example, physical layer signaling, or an MAC CE, or radio resource control (RRC) signaling, or other network signaling. And the moment instructed by the second network signaling may be, for example, a moment of a system frame, or a subframe, or a slot, or a symbol position, and the like, instructed by the second network signaling.

In one example, the first device is configured by the network device to: at the moment when the first device receives the first network signaling, or at the moment of the system frame, or the subframe, or the slot, or the symbol position, or the like, instructed by the first network signaling, start to transmit the confirmation MAC CE for the received MAC CE, and at the moment when the first device receives the first network signaling, or at the moment of the system frame, or the sub-frame, or the slot, or the symbol position, or the like, instructed by the first network signaling, start a timer, parameters of the timer being configured by the network device, and during running of the timer, transmit the confirmation MAC CE for the received MAC CE. Furthermore, the first device is configured by the network device to: when the timer expires or is not running, not transmit an confirmation MAC CE for the received MAC CE. Moreover, the first device is configured by the network device to: at the moment when the first device receives the second network signaling, or at the moment of the system frame, or the subframe, or the slot, or the symbol position, or the like, instructed by the second network signaling, stop transmission of an confirmation MAC CE for the received MAC CE; and furthermore, if the timer is still running, the first device may stop the timer.

In this embodiment, when the network device configures the first device with a logic channel having a priority higher than a predetermined priority threshold, the first device transmits the confirmation MAC CE. In one implementation, the network device may configure or predefine a priority threshold, and when the first device has a logical channel higher than the priority threshold, for example, when the first device has a URLLC service, the first device transmits an confirmation MAC CE for the received MAC CE; and furthermore, when the first device does not have a logical channel higher than the priority threshold, the first device does not transmit an confirmation MAC CE for the received MAC CE.

In this embodiment, the confirmation MAC CE transmitted by the first device and the MAC CE received by the first device have different data formats, and/or different contents of data portions, and/or different contents of subheader portions, thereby differentiating the confirmation MAC CE and the MAC CE.

In one implementation, the data format of the confirmation MAC CE may include a data portion of 0 bits and a subheader portion. A value of an LCID field of the subheader portion and a value of the LCID used by the MAC CE confirmed by the confirmation MAC CE are identical. Hence, byte overhead of the data portion of the confirmation MAC CE may be saved.

For example, an LCID used by a duplication activation/deactivation MAC CE may be configured by the network device to be “111000”, and when the first device needs to transmit an confirmation MAC CE for the MAC CE, the data format of the confirmation MAC CE is a data portion having 0 bit, and “111000” is used in the subheader as the LCID; and when the second device receives the MAC CE with the LCID field of the subheader being “111000” and a length of the data portion being 0, it determines that the MAC CE is an confirmation MAC CE for confirming the duplication activation/deactivation MAC CE.

In another implementation, the data format of the confirmation MAC CE includes a data portion and a subheader part; wherein a value of the LCID field of the data portion is identical to a value of the LCID used by the MAC CE confirmed by the confirmation MAC CE, and a value of the LCID field of the subheader is a predetermined value. Hence, each confirmation MAC CE has a uniform data format.

For example, an LCID used by a duplication activation/deactivation MAC CE may be configured by the network device to be “111000”, and when the first device transmits an confirmation MAC CE for the MAC CE, a data format of the confirmation MAC CE is that: a data portion contains an LCID field, a value of which being set to be “111000”, and a subheader portion uses an LCID having a predetermined value, such as “110111”. And when the second device receives the MAC CE with the LCID field of the subheader portion being “110111” and the LCID field of the data portion being “111000”, it determines that the MAC CE is an confirmation MAC CE for confirming the duplication activation/deactivation MAC CE.

In yet another implementation, the data format of the confirmation MAC CE includes a subheader portion and a data portion of 0 bit; wherein a value of the LCID field of the subheader portion is a predetermined value. Hence, each confirmation MAC CE has a uniform data format, and byte overhead of the data portion of the confirmation MAC CE may be saved.

For example, an LCID used by a duplication activation/deactivation MAC CE is configured to be “111000” by the network device. Within a configured period of time after the second device transmits the MAC CE, such as within a preconfigured window or timer allowed period, when the first device transmits an confirmation MAC CE for the MAC CE, a data format of the confirmation MAC CE is that: a data portion is of 0 bit, and a subheader portion uses an LCID having a predetermined value, such as “110111”. And when the second device receives the MAC CE with the LCID field of the subheader portion being “110111” and a length of the data portion being 0 with a period of time after transmitting the duplication activation/deactivation MAC CE, it determines that the MAC CE is an confirmation MAC CE for confirming the duplication activation/deactivation MAC CE.

According to this embodiment, the first device transmits the confirmation MAC CE for the received MAC CE. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified.

### Embodiment 2

Embodiment 2 of this disclosure provides a method for confirming an MAC CE, which is performed by a second device.

FIG. 3 is a schematic diagram of the method for confirming an MAC CE of Embodiment 2. As shown in FIG. 3, the method includes:

block 301: a second device transmits an MAC CE to a first device; and

block 302: the second device receives an confirmation MAC CE confirming that the first device successfully receives the MAC CE and transmitted by the first device.

According to this embodiment, the second device receives the confirmation MAC CE confirming that the first device successfully receives the MAC CE and transmitted by the first device, thereby improving reliability of the MAC CE.

In this embodiment, reference may be made to Embodiment 1 for description of the first device and the second device.

In this embodiment, when the second device instructes, the first device transmits the confirmation MAC CE. For example, the MAC CE transmitted by the second device is used to instruct that the first device transmits the confirmation MAC CE; or a field of a data portion or a subheader portion of the MAC CE is used to perform the instruction; an logical channel identifier (LCID) used by the MAC CE is used to perform the instruction; or a position of the MAC CE in a media access control protocol data unit (MAC PDU) received by the first device is used to perform the instruction.

In this embodiment, when a network device in the first device and the second device configures the first device, the first device transmits the confirmation MAC CE. For example, the first device is configured by the network device to transmit the confirmation MAC CE at a moment when first network signaling is received or within a duration starting from a moment instructed by the first network signaling. A length of the duration is determined by a timer configured by the network device, and/or the first device is further configured by the network device to terminate transmission of the confirmation MAC CE at a moment when second network signaling is received or a moment instructed by the second network signaling.

In this embodiment, when the network device configures the first device with a logic channel having a priority higher than a predetermined priority threshold, the first device transmits the confirmation MAC CE.

In this embodiment, the confirmation MAC CE and the MAC CE have different data formats, and/or different contents of data portions, and/or different contents of subheader portions. For example, the data format of the confirmation MAC CE may include a data portion of 0 bits and a subheader portion, a value of an LCID field of the subheader portion and a value of the LCID used by the MAC CE confirmed by the confirmation MAC CE are identical; or the data format of the confirmation MAC CE may include a data portion and a subheader portion, wherein a value of an LCID field of the data portion and a value of the LCID used by the MAC CE confirmed by the confirmation MAC CE are identical, and a value of the LCID of the subheader portion is a predetermined value; the data format of the confirmation MAC CE may include a data portion of 0 bits and a subheader portion, wherein a value of an LCID field of the subheader portion is a predetermined value.

In this embodiment, reference may be made to Embodiment 1 for contents identical to those in Embodiment, which shall not be described herein any further.

According to this embodiment, the second device receives the confirmation MAC CE for the received MAC CE transmitted by the first device. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified by the second device.

### Embodiment 3

Embodiment 3 of this disclosure provides an apparatus for confirming an MAC CE. As a principle of the apparatus for solving problems is similar to that of the method in Embodiment 1, reference may be made to the implementation of the method in Embodiment 1 for implementation of the apparatus, with identical contents being not going to be described herein any further.

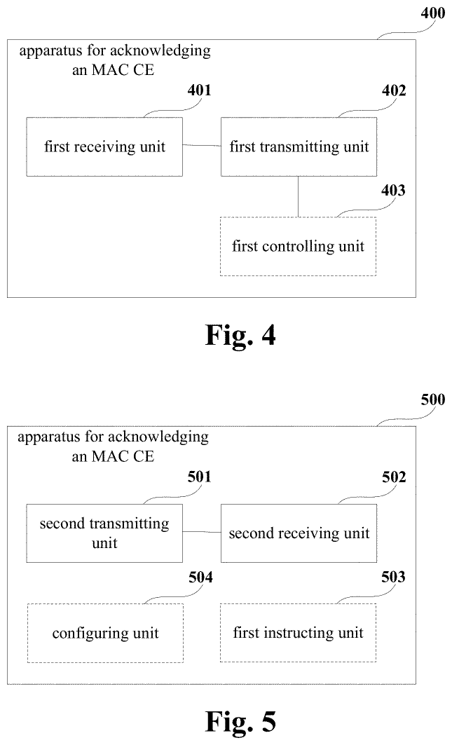

FIG. 4 is a schematic diagram of the apparatus for confirming an MAC CE of Embodiment 3. As shown in FIG. 4, an apparatus 400 includes: a first receiving unit 401 and a first transmitting unit 402.

In this embodiment, the first receiving unit 401 is configured to receive an MAC CE transmitted by a second device, and the first transmitting unit 402 is configured to transmit an confirmation MAC CE confirming that the first receiving unit successfully receives the MAC CE.

In this embodiment, as shown in FIG. 4, the apparatus 400 may further include: a first controlling unit 403.

In this embodiment, when the first controlling unit 403 determines that the first device is instructed by the second device, the first controlling unit controls the first transmitting unit 402 to transmit the confirmation MAC CE.

In one implementation, according to the MAC CE transmitted by the second device, the first controlling unit 403 determines that the first device is instructed by the second device to transmit the confirmation MAC CE. For example, the first controlling unit 403 determines the instruction according to a field of a data portion or subheader portion of the MAC CE; or the first controlling unit determines the instruction according to a logic channel identifier (LCID) used by the MAC CE; or the first controlling unit determines the instruction according to a position of the MAC CE in a media access control protocol data unit (MAC PDU) received by the first device. In another implementation, when the first controlling unit 403 is configured by a network device in the first device and the second device, the first controlling unit 403 controls the first transmitting unit 402 to transmit the confirmation MAC CE.

For example, the controlling unit is configured by the network device to perform the following control: at a moment when the first receiving unit 401 receives first network signaling or within a duration starting from a moment instructed by the first network signaling, controlling the first transmitting unit 402 to transmit the confirmation MAC CE, a length of the duration is determined by a timer configured by the network device; or the controlling unit is further configured by the network device to perform the following control: at a moment when the first receiving unit receives second network signaling or a moment instructed by the second network signaling, controlling the first transmitting unit to terminate transmission of the confirmation MAC CE.

In a further implementation, the first controlling unit 403 is configured by the network device to perform the following control: when the network device configures the first device with a logic channel having a priority higher than a predetermined priority threshold, controlling the first transmitting unit 402 to transmit the confirmation MAC CE.

Furthermore, when the first device is a network device, the apparatus 400 may further include a configuring unit (not shown) used to configure the first controlling unit 403 so that the first controlling unit 403 is configured to perform the above controlling.

In this embodiment, the confirmation MAC CE and the MAC CE have different data formats, and/or different contents of data portions, and/or different contents of subheader portions. For example, the data format of the confirmation MAC CE may include a data portion of 0 bits and a subheader portion; a value of an LCID field of the subheader portion and a value of the LCID used by the MAC CE confirmed by the confirmation MAC CE are identical; or the data format of the confirmation MAC CE may include a data portion and a subheader portion, a value of an LCID field of the data portion and a value of the LCID used by the MAC CE confirmed by the confirmation MAC CE are identical, and a value of the LCID of the subheader portion is a predetermined value; or the data format of the confirmation MAC CE may include a data portion of 0 bits and a subheader portion, wherein a value of an LCID field of the subheader portion is a predetermined value.

According to this embodiment, the first device transmits the confirmation MAC CE for the received MAC CE. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified.

### Embodiment 4

Embodiment 4 of this disclosure provides an apparatus for confirming an MAC CE. As a principle of the apparatus for solving problems is similar to that of the method in Embodiment 2, reference may be made to the implementation of the method in Embodiment 2 for implementation of the apparatus, with identical contents being not going to be described herein any further.

FIG. 5 is a schematic diagram of the apparatus for confirming an MAC CE of Embodiment 4. As shown in FIG. 5, an apparatus 500 includes: a second transmitting unit 501 and a second receiving unit 502.

In this embodiment, the second transmitting unit 501 is configured to transmit an MAC CE to a first device, and the second receiving unit 502 is configured to receive an confirmation MAC CE confirming that the first device successfully receives the MAC CE and transmitted by the first device.

In this embodiment, as shown in FIG. 5, the apparatus 500 further includes a first instructing unit 503; when the first instructing unit 503 instructes, the first device transmits the confirmation MAC CE.

In one implementation, the first instructing unit 503 sets the MAC CE transmitted by the second device, to instruct that the first device transmits the confirmation MAC CE. For example, the first instructing unit 503 sets a field of a data portion or a subheader portion of the MAC CE to perform the instruction; or the first instructing unit 503 sets a logical channel identifier (LCID) used by the MAC CE to perform the instruction; or the first instructing unit 503 sets a position of the MAC CE in a media access control protocol data unit (MAC PDU) to perform the instruction.

In this embodiment, when a network device in the first device and the second device configures, the first device transmits the confirmation MAC CE; wherein, as shown in FIG. 5, when the second device is the network device, the apparatus 500 may further include a configuring unit 504, which is the same as the configuring unit in Embodiment 3.

In one implementation, the configuring unit 504 configures that the first device transmits the confirmation MAC CE at a moment when first network signaling is received or within a duration starting from a moment instructed by the first network signaling, wherein a length of the duration is determined by a timer configured by the configuring unit; and/or the configuring unit 504 configures that the first device terminates transmission of the confirmation MAC CE at a moment when second network signaling is received or a moment instructed by the second network signaling.

In another implementation, the configuring unit 504 configures the first device with a logic channel, and configures the first device to: when the configuring unit 504 configures the first device with a logic channel having a priority higher than a predetermined priority threshold, transmit the confirmation MAC CE.

In this embodiment, the confirmation MAC CE and the MAC CE have different data formats, and/or different contents of data portions, and/or different contents of subheader portions. For example, the data format of the confirmation MAC CE may include a data portion of 0 bits and a subheader portion, wherein a value of an LCID field of the subheader portion and a value of the LCID used by the MAC CE confirmed by the confirmation MAC CE are identical; or the data format of the confirmation MAC CE may include a data portion and a subheader portion, a value of an LCID field of the data portion and a value of the LCID used by the MAC CE confirmed by the confirmation MAC CE are identical, and a value of the LCID of the subheader portion is a predetermined value; or the data format of the confirmation MAC CE may include a data portion of 0 bits and a subheader portion, wherein a value of an LCID field of the subheader portion is a predetermined value.

According to this embodiment, the second device receives the confirmation MAC CE for the received MAC CE transmitted by the first device. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified by the second device.

### Embodiment 5

Embodiment 5 of this disclosure provides a device, which is a first device. As a principle of the device for solving problems is similar to that of the method in Embodiment 1, reference may be made to the implementation of the method in Embodiment 1 for implementation of the device, with identical contents being not going to be described herein any further.

In this embodiment, the first device may be a network device, or may be a terminal equipment.

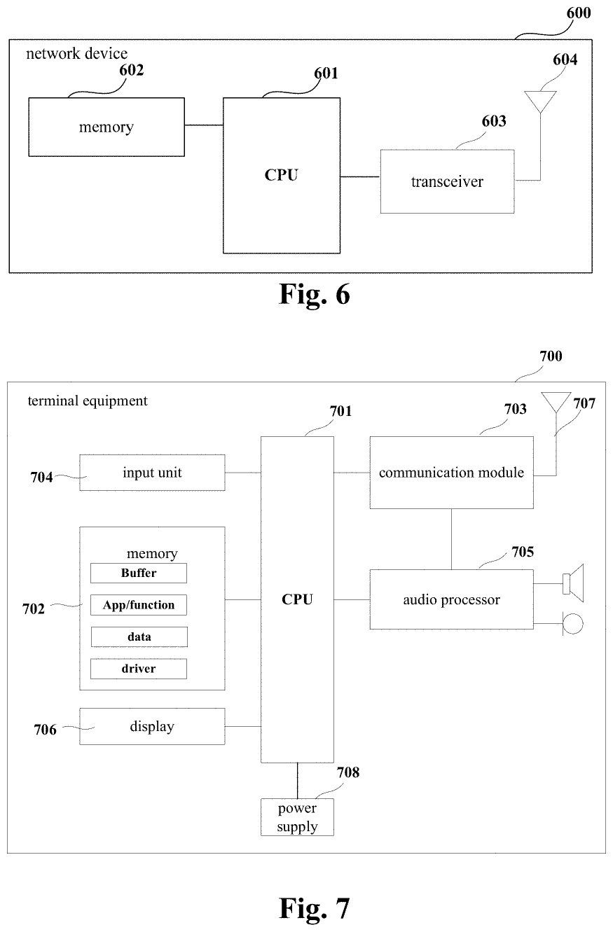

FIG. 6 is a schematic diagram of a structure the network device of the embodiment of this disclosure. As shown in FIG. 6, a network device 600 may include a central processing unit (CPU) 601 and a memory 602, the memory 602 being coupled to the central processing unit 601. The memory 602 may store various data, and furthermore, it may store a program for data processing, and execute the program under control of the central processing unit 601.

In one implementation, the functions of the apparatus 400 may be integrated into the central processing unit 601, wherein the central processing unit 601 may be configured to perform the method for confirming an MAC CE described in Embodiment 1.

For example, the central processing unit 601 may be configured to perform control, so that the network device 600 carries out the method described in Embodiment 1.

Furthermore, reference may be made to Embodiment 1 for other configuration manners of the central processing unit 601, which shall not be described herein any further.

In another implementation, the above apparatus 400 and the central processing unit 601 may be configured separately; for example, the apparatus 400 may be configured as a chip connected to the central processing unit 601, such as the units shown in FIG. 6, and the functions of the apparatus 400 are executed under control of the central processing unit 601.

Furthermore, as shown in FIG. 6, the network device 600 may further include a transceiver 603, and an antenna 604, etc. Functions of the above components are similar to those in the related art, and shall not be described herein any further. It should be noted that the network device 600 does not necessarily include all the parts shown in FIG. 6. Furthermore, the network device 600 may include parts not shown in FIG. 6, and the related art may be referred to.

FIG. 7 is a schematic diagram of a structure the terminal equipment of the embodiment of this disclosure. As shown in FIG. 7, a terminal equipment 700 may include a central processing unit (CPU) 701 and a memory 702, the memory 702 being coupled to the central processing unit 701. For example, the memory 702 may store various data, and furthermore, it may store a program for data processing, and execute the program under control of the central processing unit 701, to confirm an MAC CE.

In one implementation, the functions of the apparatus 400 in Embodiment 3 may be integrated into the central processing unit 701, wherein the central processing unit 701 may be configured to perform the method for confirming an MAC CE described in Embodiment 1.

For example, the central processing unit 701 may be configured to perform control, so that the terminal equipment 700 carries out the method described in Embodiment 1.

Furthermore, reference may be made to Embodiment 1 for other configuration manners of the central processing unit 701, which shall not be described herein any further.

In another implementation, the above apparatus 400 and the central processing unit 701 may be configured separately; for example, the apparatus 400 may be configured as a chip connected to the central processing unit 701, such as the units shown in FIG. 7, and the functions of the apparatus 400 are executed under control of the central processing unit 701.

Furthermore, as shown in FIG. 7, the terminal equipment 700 may include a communication module 703, an input unit 704, a display 706, an audio processor 705, an antenna 707, and a power supply 708, etc. Functions of the above components are similar to those in the related art, and shall not be described herein any further. It should be noted that the terminal equipment 700 does not necessarily include all the parts shown in FIG. 7. Furthermore, the terminal equipment 700 may include parts not shown in FIG. 7, and the related art may be referred to.

According to this embodiment, the first device transmits the confirmation MAC CE for the received MAC CE. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified.

### Embodiment 6

Embodiment 6 of this disclosure provides a device, which is a second device. As a principle of the device for solving problems is similar to that of the method in Embodiment 2, reference may be made to the implementation of the method in Embodiment 2 for implementation of the device, with identical contents being not going to be described herein any further.

In this embodiment, the second device may be a network device, and a schematic diagram of which may be identical to that shown in FIG. 6.

In one implementation, the functions of the apparatus 500 in Embodiment 4 may be integrated into the central processing unit 601 of the network device 600, wherein the central processing unit 601 may be configured to perform the method for confirming an MAC CE described in Embodiment 2.

For example, the central processing unit 601 may be configured to perform control, so that the network device 600 carries out the method described in Embodiment 2.

Furthermore, reference may be made to Embodiment 2 for other configuration manners of the central processing unit 601, which shall not be described herein any further.

In another implementation, the above apparatus 500 and the central processing unit 601 may be configured separately; for example, the apparatus 500 may be configured as a chip connected to the central processing unit 601, such as the units shown in FIG. 6, and the functions of the apparatus 500 are executed under control of the central processing unit 601.

In this embodiment, the second device may also be a terminal equipment, and a schematic diagram of which may be identical to that shown in FIG. 7.

In one implementation, the functions of the apparatus 500 in Embodiment 4 may be integrated into the central processing unit 701 of the terminal equipment 700, wherein the central processing unit 701 may be configured to perform the method for confirming an MAC CE described in Embodiment 2.

For example, the central processing unit 701 may be configured to perform control, so that the terminal equipment 700 carries out the method described in Embodiment 2.

Furthermore, reference may be made to Embodiment 2 for other configuration manners of the central processing unit 701, which shall not be described herein any further.

In another implementation, the above apparatus 500 and the central processing unit 701 may be configured separately; for example, the apparatus 500 may be configured as a chip connected to the central processing unit 701, such as the units shown in FIG. 7, and the functions of the apparatus 500 are executed under control of the central processing unit 701.

According to this embodiment, the second device receives the confirmation MAC CE for the received MAC CE transmitted by the first device. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified by the second device.

### Embodiment 7

Embodiment 7 of this disclosure provides a communication system, which at least includes the first device in Embodiment 5 and the second device in Embodiment 6; wherein the first device may be a network device, and the second device may be a terminal equipment, or the first device may be a terminal equipment, and the second device may be a network device. Contents of Embodiment 5 and Embodiment 6 are incorporated herein, which shall not be described herein any further.

According to this embodiment, the second device receives the confirmation MAC CE for the received MAC CE transmitted by the first device. Hence, it may be confirmed that the first device successfully receives the MAC CE, thereby improving the reliability of the MAC CE. And furthermore, the confirmation MAC CE is different from the MAC CE, hence, the confirmation MAC CE may be easily identified by the second device.

An embodiment of the present disclosure provides a storage medium, including a computer readable program code, which will cause an apparatus for confirming an MAC CE or a first device to perform the method for confirming an MAC CE as described in Embodiment 1.

An embodiment of the present disclosure provides a computer readable program code, which, when executed in an apparatus for confirming an MAC CE or a first device, will cause the apparatus for confirming an MAC CE or the first device to perform the method for confirming an MAC CE as described in Embodiment 1.

An embodiment of the present disclosure provides a storage medium, including a computer readable program code, which will cause an apparatus for confirming an MAC CE or a second device to perform the method for confirming an MAC CE as described in Embodiment 2.

An embodiment of the present disclosure provides a computer readable program code, which, when executed in an apparatus for confirming an MAC CE or a second device, will cause the apparatus for confirming an MAC CE or the second device to perform the method for confirming an MAC CE as described in Embodiment 2.

### Embodiment 8

Embodiment 8 of this disclosure provides a method for applying configuration in radio resource control (RRC) configuration signaling, which is performed by a terminal equipment.

In the related art, a network device is unable to know a physical time and used physical resources for transmitting RRC configuration signaling therefor, hence, it is unable to accurately know a moment when a terminal equipment successfully receives the RRC configuration signaling, which results in out-of-synchronization of applying new configuration at the network device and the terminal equipment side, and inconsistence of configuration used by the network device and the terminal equipment in a period of time. In this period of time, the terminal equipment may possibly use configuration incompatible with the network device, resulting in occurrence of errors in data transmission. The incompatible configuration used by the terminal equipment during this period of time is intolerable to URLLC services.

The method for applying configuration in RRC configuration signaling in this embodiment may avoid data transmission errors caused by incompatibility of moments when a network device and a terminal equipment apply configuration in RRC configuration signaling.

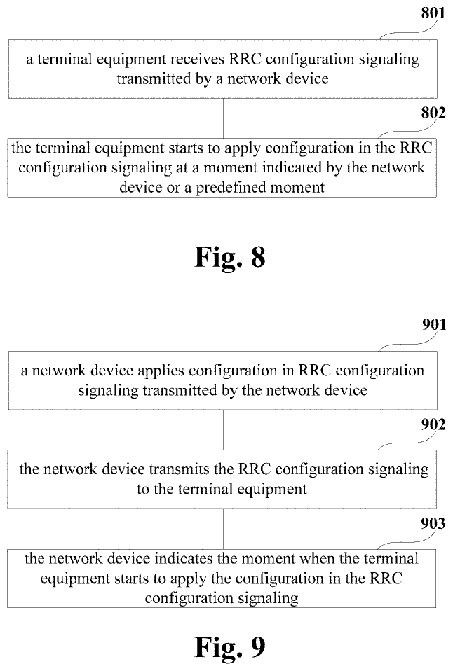

FIG. 8 is a schematic diagram of the method for applying configuration in RRC configuration signaling in this embodiment. As shown in FIG. 8, the method includes:

block 801: a terminal equipment receives RRC configuration signaling transmitted by a network device; and

block 802: the terminal equipment starts to apply configuration in the RRC configuration signaling at a moment instructed by the network device or a predefined moment.

According to this embodiment, the terminal equipment starts to apply the configuration in the RRC configuration signaling at the moment instructed by the network device or the predefined moment. Thus, it is possible to avoid data transmission errors caused by incompatibility of moments when the network device and the terminal equipment apply the configuration in the RRC configuration signaling.

In block 802 of this embodiment, the terminal equipment may start to apply the configuration in the RRC configuration signaling at the moment instructed by the network device, wherein the moment instructed by the network device may be one of at least two alternative moments.

In this embodiment, the alternative moment may include a first moment, which is a moment when the terminal equipment successfully receives the RRC configuration signaling, or a moment when the terminal equipment transmits or delivers an RRC complete message to which the RRC configuration signaling corresponds to a lower layer; and/or, the alternative moment may include a second moment, which is a moment instructed by the network device or a predefined moment; for example, the second moment may be a moment of a specific system frame number, or a specific subframe number, or a specific slot position, or a specific symbol position, etc.

In one example, the RRC configuration signaling is reconfiguration setting signaling of resources used by URLLC services of the terminal equipment. A field in the RRC configuration signaling is used to instruct the first moment or the second moment when the terminal equipment applies the configuration in the RRC configuration signaling. If this field is set to be of a first value, the terminal equipment will start to apply the configuration at the first moment, which may be, for example, a moment when the RRC signaling is successfully received or a moment when the UE transmits the RRC complete message corresponding to the RRC configuration signaling or delivers the RRC complete message to a lower layer; and if this field is set to be of a second value, the terminal equipment will apply the configuration at the second moment, which may be a specific moment instructed by the network device; for example, the network device preconfigures that a moment of a first symbol position of a first subframe of odd-numbered subframes in a system frame number (SFN) is taken as the second moment.

According to this embodiment, the terminal equipment starts to apply the configuration in the RRC configuration signaling at the moment instructed by the network device or the pre-defined moment. Thus, it is possible to avoid data transmission errors caused by incompatibility of moments when the network device and the terminal equipment apply the configuration in the RRC configuration signaling.

### Embodiment 9

Embodiment 9 of this disclosure provides a method for applying configuration in radio resource control (RRC) configuration signaling, which is performed by a network device.

FIG. 9 is a schematic diagram of the method for applying configuration in RRC configuration signaling of Embodiment 9. As shown in FIG. 9, the method includes:

block 901: a network device applies configuration in RRC configuration signaling transmitted by the network device.

In this embodiment, a moment when the network device applies the configuration is determined by a service related to the configuration; wherein the service refers to a high-reliability and low-latency service, such as an ultra reliable & low latency communication (URLLC) service.

In one implementation, in a case where the service is to be initiated or the RRC configuration signaling is transmitted before the service is initiated, the network device applies the configuration earlier than the terminal equipment. For the determination that the service is to be initiated, reference may be made to existing techniques. For example, when the service is initiated by the network device, the network device may determine that the service is to be initiated; and when the service is initiated by the terminal equipment, the network device may monitor, to determine that the service is to be initiated.

In the above implementation, that the network device applies the configuration earlier than the terminal equipment refers to that the configuration is applied at the moment to which transmitting or delivering to the lower layer the RRC configuration signaling by the network device corresponds.

According to the above implementation, it is possible to ensure that the network device applies the configuration performed for the URLLC service earlier than the terminal equipment. Even if the moments for applying the configuration by the network device and the terminal equipment are different, it may be ensured that data of the URLLC service to be initiated may be transmitted under correct configuration, thereby ensuring reliability of the data of the URLLC service.

For example, the URLLC service of the terminal equipment has not yet started, but the URLLC service is to be initiated. The network device makes preparation for the URLLC service via the RRC configuration signaling. When the network device transmits the RRC configuration signaling, the network device may apply the configuration at the moment when the network device transmits or delivers to the lower layer the RRC configuration signaling.

In another implementation, when the service is to be ended or the RRC configuration signaling is transmitted after or during the service is initiated, the network device applies the configuration later than the terminal equipment. That the network device applies the configuration later than the terminal equipment refers to that the configuration is applied at the moment when the network side receives an RRC complete message corresponding to the RRC configuration message.

According to the above implementation, it is possible to ensure that the network device is later than the terminal equipment in applying the configuration used after the URLLC service is stopped. Even if the moments for applying the configuration by the network device and the terminal equipment are different, it may be ensured that ongoing data of the URLLC service may be transmitted under correct configuration, thereby ensuring reliability of the data of the URLLC service.

For example, the URLLC of the terminal equipment has been started and is ongoing. When the URLLC service is to be ended, the network device changes related configuration of a resource via the RRC configuration. At this moment, the network device may apply the configuration at the moment when the RRC complete message corresponding to the RRC configuration message is received.

In this embodiment, as shown in FIG. 9, the method may further include:

block 902: the network device transmits the RRC configuration signaling to the terminal equipment; and

block 903: the network device instructs the moment when the terminal equipment starts to apply the configuration in the RRC configuration signaling.

In block 902 of this embodiment, the network device may instruct at one of at least two alternative moments when the terminal equipment starts to apply the configuration in the RRC configuration signaling.

In this embodiment, the alternative moment may include a first moment, which is a moment when the terminal equipment successfully receives the RRC configuration signaling, or a moment when the terminal equipment transmits or delivers an RRC complete message to which the RRC configuration signaling corresponds to a lower layer; and/or, the alternative moment may include a second moment, which is a moment instructed by the network device or a predefined moment. For the description of the first moment and the second moment, reference may be made to Embodiment 8, which shall not be described herein any further.

According to this embodiment, the network device may apply the configuration for the URLLC service earlier than the terminal equipment, and/or the network device may be later than the terminal equipment in applying the configuration used after the URLLC service is stopped, thereby ensuring that the data of the URLLC service be initiated and/or the ongoing URLLC service may be transmitted under correct configuration, and ensuring reliability of the data of the URLLC service; and furthermore, the network device may instruct the moment when the terminal equipment starts to apply the configuration in the RRC configuration signaling. Thus, it is possible to avoid data transmission errors caused by incompatibility of moments when the network device and the terminal equipment apply the configuration in the RRC configuration signaling.

Embodiment 1

Embodiment 10 of this disclosure provides an apparatus for applying configuration in radio resource control (RRC) configuration signaling, applicable to a terminal equipment. As a principle of the apparatus for solving problems is similar to that of the method in Embodiment 8, reference may be made to the implementation of the method in Embodiment 8 for implementation of the apparatus, with identical contents being not going to be described herein any further.

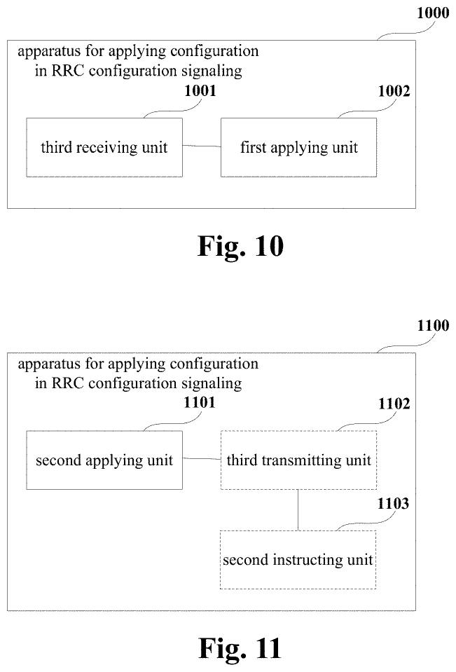

FIG. 10 is a schematic diagram of the apparatus for applying configuration in RRC configuration signaling in Embodiment 10. As shown in FIG. 10, an apparatus 1000 includes a third receiving unit 1001 and a first applying unit 1002.

In this embodiment, the third receiving unit 1001 is configured to receive RRC configuration signaling transmitted by a network device, and the first applying unit 1002 is configured to start to apply configuration in the RRC configuration signaling to the terminal equipment at a moment instructed by the network device or a predefined moment.

In this embodiment, the first applying unit 1002 may start to apply the configuration in the RRC configuration signaling at the moment instructed by the network device, wherein the moment instructed by the network device may be one of at least two alternative moments.

In this embodiment, the alternative moment may include a first moment, which is a moment when the terminal equipment successfully receives the RRC configuration signaling, or a moment when the terminal equipment transmits or delivers an RRC complete message to which the RRC configuration signaling corresponds to a lower layer; and/or, the alternative moment may include a second moment, which is a moment instructed by the network device or a predefined moment.

According to this embodiment, the terminal equipment starts to apply the configuration in the RRC configuration signaling at the moment instructed by the network device or the pre-defined moment. Thus, it is possible to avoid data transmission errors caused by incompatibility of moments when the network device and the terminal equipment apply the configuration in the RRC configuration signaling.

### Embodiment 11

Embodiment 11 of this disclosure provides an apparatus for applying configuration in radio resource control (RRC) configuration signaling, applicable to a network device. As a principle of the apparatus for solving problems is similar to that of the method in Embodiment 9, reference may be made to the implementation of the method in Embodiment 9 for implementation of the apparatus, with identical contents being not going to be described herein any further.

FIG. 11 is a schematic diagram of the apparatus for applying configuration in RRC configuration signaling in Embodiment 11. As shown in FIG. 11, an apparatus 1100 includes a second applying unit 1101.

In this embodiment, the second applying unit 1101 is configured to apply configuration in RRC configuration signaling transmitted by the network device to the network device. A moment when the second applying unit 1101 applies the configuration is determined by a service related to the configuration. The service is, for example, an ultra reliable & low latency communication (URLLC) service.

In this embodiment, in a case where the service is to be initiated or the RRC configuration signaling is transmitted before the service is initiated, the second applying unit applies the configuration to the network device earlier than the terminal equipment. That the second applying unit applies the configuration to the network device earlier than the terminal equipment refers to that the configuration is applied at the moment to which transmitting or delivering the RRC configuration signaling by the network device to the lower layer corresponds.

In this embodiment, when the service is to be ended or the RRC configuration signaling is transmitted after or during the service is initiated, the second applying unit applies the configuration to the network device later than the terminal equipment. That the second applying unit applies the configuration to the network device later than the terminal equipment refers to that the configuration is applied at the moment when the network device receives an RRC complete message corresponding to the RRC configuration message.

In this embodiment, as shown in FIG. 11, the apparatus 1100 may further include: a third transmitting unit 1102 and a second instructing unit 1103.

In this embodiment, the third transmitting unit 1102 is configured to transmit RRC configuration signaling to the terminal equipment, and the second instructing unit 1103 is configured to instruct the moment when the terminal equipment starts to apply the configuration in the RRC configuration signaling.

In this embodiment, the second instructing unit 1103 may instruct that the terminal equipment starts to apply the configuration in the RRC configuration signaling at one of at least two alternative moments when. The alternative moment may include a first moment, which is a moment when the terminal equipment successfully receives the RRC configuration signaling, or a moment when the terminal equipment transmits or delivers an RRC complete message to which the RRC configuration signaling corresponds to a lower layer; and/or, the alternative moment may include a second moment, which is a moment instructed by the network device or a predefined moment.

According to this embodiment, the network device may apply the configuration for the URLLC service earlier than the terminal equipment, and/or the network device may be later than the terminal equipment in applying the configuration used after the URLLC service is stopped, thereby ensuring that the data of the URLLC service be initiated and/or the ongoing URLLC service may be transmitted under correct configuration, and ensuring reliability of the data of the URLLC service; and furthermore, the network device may instruct the moment when the terminal equipment starts to apply the configuration in the RRC configuration signaling. Thus, it is possible to avoid data transmission errors caused by incompatibility of moments when the network device and the terminal equipment apply the configuration in the RRC configuration signaling.

### Embodiment 12

Embodiment 12 of this disclosure provides a terminal equipment. As a principle of the terminal equipment for solving problems is similar to that of the method in Embodiment 8, reference may be made to the implementation of the method in Embodiment 8 for implementation of the terminal equipment, with identical contents being not going to be described herein any further.

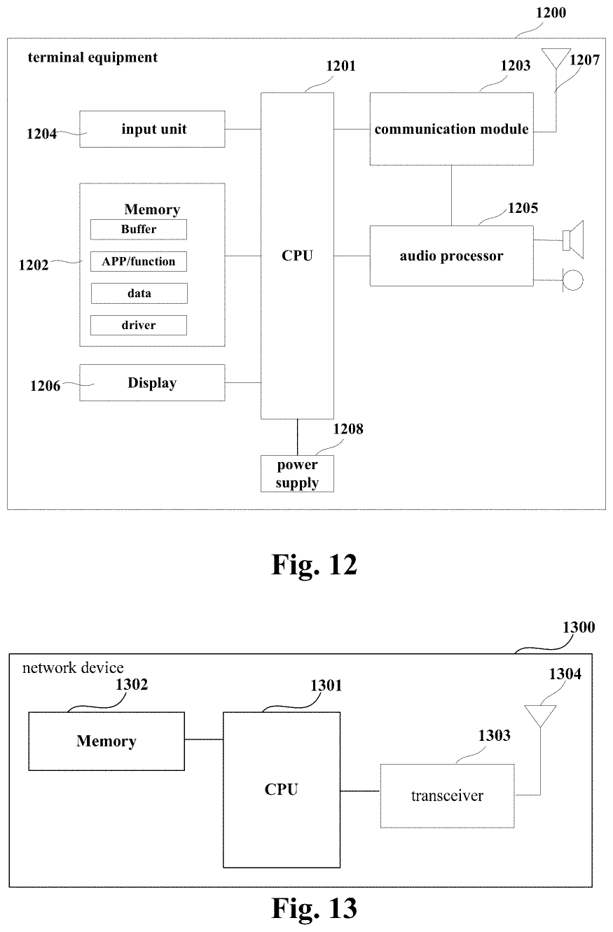

FIG. 12 is a schematic diagram of a structure the terminal equipment of the embodiment of this disclosure. As shown in FIG. 12, a terminal equipment 1200 may include a central processing unit (CPU) 1201 and a memory 1202, the memory 1202 being coupled to the central processing unit 1201. For example, the memory 1202 may store various data, and furthermore, it may store a program for data processing, and execute the program under control of the central processing unit 1201.

In one implementation, the functions of the apparatus 1000 in Embodiment 10 may be integrated into the central processing unit 1201, wherein the central processing unit 1201 may be configured to perform the method for applying configuration in RRC configuration signaling described in Embodiment 8.

For example, the central processing unit 1201 may be configured to perform control, so that the terminal equipment 1200 carries out the method described in Embodiment 8.

Furthermore, reference may be made to Embodiment 8 for other configuration manners of the central processing unit 1201, which shall not be described herein any further.

In another implementation, the above apparatus 1000 and the central processing unit 1201 may be configured separately; for example, the apparatus 1000 may be configured as a chip connected to the central processing unit 1201, such as the units shown in FIG. 12, and the functions of the apparatus 1000 are executed under control of the central processing unit 1201.

Furthermore, as shown in FIG. 12, the terminal equipment 1200 may further include a communication module 1203, an input unit 1204, a display 1206, an audio processor 1205, an antenna 1207, and a power supply 1208, etc. Functions of the above components are similar to those in the related art, and shall not be described herein any further. It should be noted that the terminal equipment 1200 does not necessarily include all the parts shown in FIG. 12. Furthermore, the terminal equipment 1200 may include parts not shown in FIG. 12, and the related art may be referred to.

According to this embodiment, the terminal equipment starts to apply the configuration in the RRC configuration signaling at the moment instructed by the network device or the pre-defined moment. Thus, it is possible to avoid data transmission errors caused by incompatibility of moments when the network device and the terminal equipment apply the configuration in the RRC configuration signaling.

Embodiment 13

Embodiment 13 of this disclosure provides a network device. As a principle of the device for solving problems is similar to that of the method in Embodiment 9, reference may be made to the implementation of the method in Embodiment 9 for implementation of the device, with identical contents being not going to be described herein any further.

FIG. 13 is a schematic diagram of a structure the network device of the embodiment of this disclosure. As shown in FIG. 13, a network device 1300 may include a central processing unit (CPU) 1301 and a memory 1302, the memory 1302 being coupled to the central processing unit 1301. For example, the memory 1302 may store various data, and furthermore, it may store a program for data processing, and execute the program under control of the central processing unit 1301.

In one implementation, the functions of the apparatus 1100 may be integrated into the central processing unit 1301, wherein the central processing unit 1301 may be configured to perform the method for applying configuration in RRC configuration signaling described in Embodiment 9.

For example, the central processing unit 1301 may be configured to perform control, so that the network device 1300 carries out the method described in Embodiment 9.

Furthermore, reference may be made to Embodiment 9 for other configuration manners of the central processing unit 1301, which shall not be described herein any further.

In another implementation, the above apparatus 1100 and the central processing unit 1301 may be configured separately; for example, the apparatus 1100 may be configured as a chip connected to the central processing unit 1301, such as the units shown in FIG. 13, and the functions of the apparatus 1100 are executed under control of the central processing unit 1301.

Furthermore, as shown in FIG. 13, the network device 1300 may further include a transceiver 1303, and an antenna 1304, etc. Functions of the above components are similar to those in the related art, and shall not be described herein any further. It should be noted that the network device 1300 does not necessarily include all the parts shown in FIG. 13. Furthermore, the network device 1300 may include parts not shown in FIG. 13, and the related art may be referred to.

According to this embodiment, the network device may apply the configuration for the URLLC service earlier than the terminal equipment, and/or the network device may be later than the terminal equipment in applying the configuration used after the URLLC service is stopped, thereby ensuring that the data of the URLLC service be initiated and/or the ongoing URLLC service may be transmitted under correct configuration, and ensuring reliability of the data of the URLLC service; and furthermore, the network device may instruct the moment when the terminal equipment starts to apply the configuration in the RRC configuration signaling. Thus, it is possible to avoid data transmission errors caused by incompatibility of moments when the network device and the terminal equipment apply the configuration in the RRC configuration signaling.

Embodiment 14

Embodiment 14 of this disclosure provides a communication system, which at least includes the terminal equipment in Embodiment 12 and the network device in Embodiment 13, contents of which being incorporated herein, which shall not be described herein any further.

According to this embodiment, it is possible to avoid data transmission errors caused by incompatibility of moments when the network device and the terminal equipment apply configuration in RRC configuration signaling.

An embodiment of the present disclosure provides a computer storage medium, including a computer readable program code, which will cause an apparatus for applying configuration in RRC configuration signaling or a terminal equipment to perform the method for applying configuration in RRC configuration signaling as described in Embodiment 8.

An embodiment of the present disclosure provides a computer readable program code, which, when executed in an apparatus for applying configuration in RRC configuration signaling or a terminal equipment, will cause the apparatus for applying configuration in RRC configuration signaling or the terminal equipment to perform the method for applying configuration in RRC configuration signaling as described in Embodiment 8.

An embodiment of the present disclosure provides a computer storage medium, including a computer readable program code, which will cause an apparatus for applying configuration in RRC configuration signaling or a terminal equipment to perform the method for applying configuration in RRC configuration signaling as described in Embodiment 9.

An embodiment of the present disclosure provides a computer readable program code, which, when executed in an apparatus for applying configuration in RRC configuration signaling or a terminal equipment, will cause the apparatus for applying configuration in RRC configuration signaling or the terminal equipment to perform the method for applying configuration in RRC configuration signaling as described in Embodiment 9.

The above apparatuses and methods of this disclosure may be implemented by hardware, or by hardware in combination with software. This disclosure relates to such a computer-readable program that when the program is executed by a logic device, the logic device is enabled to perform the apparatus or components as described above, or to perform the methods or blocks as described above. The present disclosure also relates to a storage medium for storing the above program, such as a hard disk, a floppy disk, a CD, a DVD, and a flash memory, etc.

The processing methods performed in the apparatuses described with reference to the embodiments of this disclosure may be directly embodied as hardware, software modules executed by a processor, or a combination thereof. For example, one or more functional block diagrams and/or one or more combinations of the functional block diagrams shown in FIGS. 4, 5, 10 and 11 may either correspond to software modules of procedures of a computer program, or correspond to hardware modules. Such software modules may respectively correspond to the blocks shown in FIGS. 2, 3, 8 and 9. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 4, 5, 10 and 11 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIGS. 4, 5, 10 and 11 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

Following supplements are further provided in this disclosure.

Supplement 1. An apparatus applying configuration in radio resource control (RRC) configuration signaling, including:

a third receiving unit configured to receive RRC configuration signaling transmitted by a network device; and

a first applying unit configured to apply configuration in the RRC configuration signaling to a terminal equipment starting from a moment that is instructed by the network device or is predetermined.

Supplement 2. The apparatus according to supplement 1, wherein,

the first applying unit applies the configuration in the RRC configuration signaling starting from the moment that is instructed by the network device, the moment that is instructed by the network device being one of at least two candidate moments.

Supplement 3. The apparatus according to supplement 2, wherein,

the candidate moment includes a first moment, the first moment being a moment when the terminal equipment successfully receives the RRC configuration signaling, or a moment when the terminal equipment transmits an RRC complete message corresponding to the RRC configuration signaling or delivers the RRC complete message to a lower layer.

Supplement 4. The apparatus according to supplement 2, wherein,

the candidate moment includes a second moment, the second moment being a moment that is instructed by the network device or is predetermined.

Supplement 5. An apparatus applying configuration in radio resource control (RRC) configuration signaling, including:

a second applying unit configured to apply configuration in RRC configuration signaling transmitted by a network device to the network device;

and wherein, a moment when the second applying unit applies the configuration is determined by service related to the configuration.

Supplement 6. The apparatus according to supplement 5, wherein,

the service refers to an ultra reliable and low latency communication (URLLC) service.

Supplement 7. The apparatus according to supplement 5, wherein,

when the service is initiated or the RRC configuration signaling is transmitted before initiation of the service, the second applying unit applies the configuration to the network device earlier than the terminal equipment does.

Supplement 8. The apparatus according to supplement 7, wherein,

the second applying unit applying the configuration to the network device before the terminal equipment does refers to applying the configuration at a moment when the network device transmits the RRC configuration signaling or delivers the RRC configuration signaling to a lower layer.

Supplement 9. The apparatus according to supplement 5, wherein,

when the service shall be terminated or the RRC configuration signaling is transmitted after or while the service is initiated, the second applying unit applies the configuration to the network device later than the terminal equipment does.

Supplement 10. The apparatus according to supplement 9, wherein,

the second applying unit applying the configuration to the network device after the terminal equipment does refers to applying the configuration at a moment when the network device receives an RRC complete message corresponding to the RRC configuration signaling.

Supplement 11. The apparatus according to supplement 5, wherein the apparatus further includes:

a third transmitting unit configured to transmit the RRC configuration signaling to the terminal equipment; and

a second instructing unit configured to instruct a moment when the terminal equipment starts to apply the configuration in the RRC configuration signaling.

Supplement 12. The apparatus according to supplement 11, wherein,

the second instructing unit instructs that the terminal equipment starts to apply the configuration in the RRC configuration signaling at one of at least two candidate moments.

Supplement 13. The apparatus according to supplement 12, wherein,

the candidate moment includes a first moment, the first moment being a moment when the terminal equipment successfully receives the RRC configuration signaling, or a moment when the terminal equipment transmits an RRC complete message corresponding to the RRC configuration signaling or delivers the RRC complete message to a lower layer.

Supplement 14. The apparatus according to supplement 12, wherein,

the candidate moment includes a second moment, the second moment being a moment that is instructed by the network device or is predetermined.

Supplement 15. A communication system, including a terminal equipment and a network device, the terminal equipment including the apparatus as described in any one of supplements 1-4, and the network device including the apparatus as described in any one of supplements 5-14.

Supplement 16. An apparatus for confirming a media access control control element (MAC CE), provided in a second device, the apparatus including:

a second transmitting unit configured to transmit an MAC CE to a first device; and

a second receiving unit configured to receive an confirmation MAC CE confirming that the first device successfully receives the MAC CE and transmitted by the first device.

Supplement 17. The apparatus according to supplement 16, wherein,

the apparatus further includes an instructing unit; wherein, when the instructing device instructes, the first device transmits the confirmation MAC CE;

or, when it is configured by a network device in the first device and the second device, the first device transmits the confirmation MAC CE.

Supplement 18. The apparatus according to supplement 17, wherein,

the instructing device sets the MAC CE transmitted by the second device, to instruct the first device to transmit the confirmation MAC CE.

Supplement 19. The apparatus according to supplement 18, wherein,

the instructing device sets a field of a data portion or subheader portion of the MAC CE, to perform the instruction.

Supplement 20. The apparatus according to supplement 18, wherein,

the instructing device sets a logic channel identifier (LCID) used by the MAC CE, to perform the instruction.

Supplement 21. The apparatus according to supplement 18, wherein,

the instructing device sets a position of the MAC CE in a media access control protocol data unit (MAC PDU), to perform the instruction.

Supplement 22. The apparatus according to supplement 17, wherein,

the second device is the network device, and further includes a configuring unit;

the configuring unit configuring that the first device transmits the confirmation MAC CE at a moment when first network signaling is received or within a duration starting from a moment instructed by the first network signaling.

Supplement 23. The apparatus according to supplement 22, wherein,

a length of the duration is determined by a timer configured by the configuring unit.

Supplement 24. The apparatus according to supplement 22, wherein,

the configuring unit configures that the first device terminates transmission of the confirmation MAC CE at a moment when second network signaling is received or a moment instructed by the second network signaling.

Supplement 25. The apparatus according to supplement 17, wherein,

the second device is the network device, and further includes a configuring unit, the configuring unit configuring the first device with a logic channel, and configuring the first device that:

when the configuring unit configures the first device with a logic channel having a priority higher than a predetermined priority threshold, the first device transmits the confirmation MAC CE.

Supplement 26. The apparatus according to supplement 16, wherein,

the confirmation MAC CE and the MAC CE have different data formats, and/or different contents of data portions, and/or different contents of subheader portions.

Supplement 27. The apparatus according to supplement 26, wherein,

the data format of the confirmation MAC CE includes a data portion of 0 bit and subheader portion;

and wherein, a value of an LCID field of the subheader portion is identical to that of the LCID used by the MAC CE confirmed by the confirmation MAC CE.

Supplement 28. The apparatus according to supplement 26, wherein,

the data format of the confirmation MAC CE includes a data portion and a subheader portion;

and wherein, a value of an LCID field of the data portion is identical to that of the LCID used by the MAC CE confirmed by the confirmation MAC CE;

and a value of an LCID field of the subheader portion is a predetermined value.

Supplement 29. The apparatus according to supplement 26, wherein,

the data format of the confirmation MAC CE includes a data portion of 0 bit and subheader portion;

and wherein, a value of an LCID field of the subheader portion is a predetermined value.

What is claimed is:

1. An apparatus for confirming a media access control control element (MAC CE), provided in a first device, the apparatus comprising:
a first receiving unit configured to receive an MAC CE transmitted by a second device; and
a first transmitting unit configured to transmit an confirmation MAC CE confirming that the first receiving unit successfully receives the MAC CE.

2. The apparatus according to claim 1, wherein the apparatus further comprises:
a first controlling unit;
wherein when the first controlling unit determines that the first device is instructed by the second device, the first controlling unit controls the first transmitting unit to transmit the confirmation MAC CE; or
when the first controlling unit is configured by a network device in the first device and the second device, the first controlling unit controls the first transmitting unit to transmit the confirmation MAC CE.

3. The apparatus according to claim 2, wherein, according to the MAC CE transmitted by the second device, the first controlling unit determines that the first device is instructed by the second device to transmit the confirmation MAC CE.

4. The apparatus according to claim 3, wherein, the first controlling unit determines the instruction according to a field of a data portion or subheader portion of the MAC CE.

5. The apparatus according to claim 3, wherein, the first controlling unit determines the instruction according to a logic channel identifier (LCD) used by the MAC CE.

6. The apparatus according to claim 3, wherein, the first controlling unit determines the instruction according to a position of the MAC CE in a media access control protocol data unit (MAC PDU) received by the first device.

7. The apparatus according to claim 2, wherein,
the controlling unit is configured by the network device to perform the following control:
at a moment when the first receiving unit receives first network signaling or within a duration starting from a moment instructed by the first network signaling, controlling the first transmitting unit to transmit the confirmation MAC CE.

8. The apparatus according to claim 7, wherein,
a length of the duration is determined by a timer configured by the network device.

9. The apparatus according to claim 7, wherein the controlling unit is further configured by the network device to perform the following control:
at a moment when the first receiving unit receives second network signaling or a moment instructed by the second network signaling, controlling the first transmitting unit to terminate transmission of the confirmation MAC CE.

10. The apparatus according to claim 2, wherein,
the first controlling unit is configured by the network device to perform the following control:
when the network device configures the first device with a logic channel having a priority higher than a predetermined priority threshold, controlling the first transmitting unit to transmit the confirmation MAC CE.

11. The apparatus according to claim 1, wherein,
the confirmation MAC CE and the MAC CE have different data formats, and/or different contents of data portions, and/or different contents of subheader portions.

12. The apparatus according to claim 11, wherein,
the data format of the confirmation MAC CE comprises a data portion of 0 bit and subheader portion;
and wherein a value of a logic channel identifier (LCD) field of the subheader portion is identical to that of the LCID used by the MAC CE confirmed by the confirmation MAC CE.

13. The apparatus according to claim 11, wherein,
the data format of the confirmation MAC CE comprises a data portion and a subheader portion;
and wherein a value of an LCID field of the data portion is identical to that of the LCID used by the MAC CE confirmed by the confirmation MAC CE;
and a value of an LCID field of the subheader portion is a predetermined value.

14. The apparatus according to claim 11, wherein,
the data format of the confirmation MAC CE comprises a data portion of 0 bit and subheader portion;
and wherein a value of an LCID field of the subheader portion is a predetermined value.

15. An apparatus for confirming a media access control control element (MAC CE), provided in a second device, the apparatus comprising:
a second transmitting unit configured to transmit an MAC CE to a first device; and
a second receiving unit configured to receive an confirmation MAC CE confirming that the first device successfully receives the MAC CE and transmitted by the first device.

16. The apparatus according to claim 15, wherein,
the apparatus further comprises an instructing unit; wherein when the instructing unit instructs, the first device to transmit the confirmation MAC CE;
or, when a network device in the first device and the second device configure, the first device transmits the confirmation MAC CE.

17. The apparatus according to claim 16, wherein,
the second device is the network device, and further comprises a configuring unit;
the configuring unit configuring that the first device transmits the confirmation MAC CE at a moment when first network signaling is received or within a duration starting from a moment instructed by the first network signaling.

18. The apparatus according to claim 16, wherein,
the second device is the network device, and further comprises a configuring unit, the configuring unit configuring the first device with a logic channel, and configuring the first device that:
when the configuring unit configures the first device with a logic channel having a priority higher than a predetermined priority threshold, the first device transmits the confirmation MAC CE.

19. The apparatus according to claim 15, wherein,
the confirmation MAC CE and the MAC CE have different data formats, and/or different contents of data portions, and/or different contents of subheader portions.

20. A communication system, comprising:
a first device and a second device,
the first device comprising a first apparatus for confirming a media access control control element (MAC CE), the first apparatus including
a first receiver configured to receive an MAC CE transmitted by the second device; and
a first transmitter configured to transmit an confirmation MAC CE confirming that the first receiver successfully receives the MAC CE,
and
the second device comprising a second apparatus for confirming a media access control control element (MAC CE), the second apparatus comprising:
a second transmitter configured to transmit an MAC CE to a first device; and
a second receiver configured to receive an confirmation MAC CE confirming that the first device successfully receives the MAC CE and transmitted by the first device.
